(19) United States
(12) Patent Application Publication
(10) Pub. No.: US 2016/0367009 A1
(43) Pub. Date: Dec. 22, 2016

(54) HAIR COMB AND METHODS OF USE THEREOF

(71) Applicant: Robert Cacciabaudo, Hamilton, NJ (US)

(72) Inventor: Robert Cacciabaudo, Hamilton, NJ (US)

(21) Appl. No.: 15/186,489

(22) Filed: Jun. 19, 2016

Related U.S. Application Data
(60) Provisional application No. 62/181,931, filed on Jun. 19, 2015.

(51) Int. Cl. A45D 24/16; A01K 13/00; A45D 24/36

(52) U.S. Cl. CPC A45D 24/16; A45D 24/36; A01K 13/002

(57) ABSTRACT

A hair comb and methods of use thereof for combing, cutting, styling and de-tangling hair and animal fur, comprising a double-sided symmetrical set of substantially triangular shaped teeth extending from a raised center support element of a comb body portion attached to a handle portion. Embodiments comprise a flat bottom surface and angled top surface of a comb body portion attached to a handle, said handle also comprising a flat bottom surface that is congruous with the flat bottom surface of the comb body portion. Optional detachable attachments are provided and the handle portion may be detachably attached to the comb body portion. Cut hair length is a function of the height of the center support element of the comb body portion, which varies according to embodiments.

### PRIORITY

This application is the Non-Provisional application of Provisional Application No. 62/181,931 (Confirmation No. 9913), filed on Jun. 19, 2015 for “Hair Comb and Methods of use Thereof” by Robert Cacciabaudo (EFS ID 22683424). This Non-Provisional application claims priority to and the benefit of that Provisional Application, the contents and subject of which are incorporated herein by reference in their entirety.

### SUMMARY

The present invention relates to a hair comb and methods of use thereof. More particularly, the invention comprises a novel hair comb for use in combing, cutting and styling hair that overcomes many of the problems and obstacles encountered with using traditional flat combs for said purposes. In addition, while various embodiments of the invention are directed towards use on human hair, embodiments of the invention are also suitable for use with animals, such as pets, e.g., dogs, cats, etc., for easy combing of and detangling tangled or knotted fur.

### BACKGROUND

Hair combs come in many shapes and sizes, but historically comprise the same overall design that has been in use since at least 15^{th} century B.C. in ancient Egypt and even the stone age: a one-sided comb comprised of a plurality of teeth attached perpendicularly to a shaft portion that is also functions as a means for holding the comb. FIG. 1 depicts a modern plastic version of the traditional flat comb. Double-sided combs, wherein two sets of teeth extend perpendicular from the shaft in opposite directions (i.e., the two sets of teeth each extend perpendicular from two opposing sides of the shaft and therefore extend from the shaft 180 degrees from each other), and brushes, wherein teeth extend radially from the shaft and/or extend from an enlarged shaft or surface area connected to a handle, have also been introduced and used throughout history and are commonly known. Double-sided combs and brushes typically further comprise a handle for ease of use and are also commonly known.

Combs come in other shapes and sizes that are directed towards a specific functionality or utility. For example, nit or louse combs are used to remove fleas, lice and other microscopic parasites from the hair and scalp, and therefore, tend to be smaller in size with finer teeth. Other combs are shaped and sized with a purpose of holding or clamping hair up or in a desired fashion. Most combs, however, are directed simply to comb hair or fur, which is a process of separating and grooming the strands of hair or fur. Combs are also specifically designed for use in cutting and styling hair and encompass many shapes and sizes directed towards that purpose.

The traditional flat comb of FIG. 1 is used extensively in barbershops, hair salons, and by stylists and hair cutters for the specific purpose, function and utility of combing and cutting men's and women's hair and is manufactured in many sizes and shapes. FIG. 2 depicts several designs of typical flat hair combs used within the hair cutting and design industry. When cutting hair, stylists, cutters and barbers use the flat comb in many ways in the cutting process. In one manner, the comb is held by the stylist or barber and used to comb against the flow of the hair to pull it away from the scalp of the head of a customer to a desired length. This action allows a section of hair to be isolated through the teeth of the comb or, alternatively, the comb is transferred to the other hand and the hair is grasped by the non-cutting hand for cutting with scissors. See FIG. 3. When a desired amount and length of hair is isolated through the teeth of the comb (said amount and length of hair dependent on a number of variables as determined by the stylist or barber, such as, for example, style, hair type, thickness and thinness of hair, coarseness, hair type, etc.), the hair extending through the teeth of the comb and isolated for cutting in the desired manner generally and commonly known by those skilled in hair cutting and styling. See, e.g., “Greg Zorian's How to Cut Hair,” the substance of which is incorporate herein by reference in its entirety at the internet web site at http://www.howtocuthair.tv/tag/learn-how-to-cut-mens-hair-online/. See also, Ohnstad, Bob, Scissors and Comb Haircutting: A Cut-by-Cut Guide, You Can Publishing; Revised edition (Oct. 10, 2012), ISBN-10: 0916819000, ISBN-13: 978-0916819002. While the cited references are instructive, it should be noted that the forgoing references are not intended to limit in any way the innumerable methods and manners of cutting and styling hair with a comb, all of which are known in the art.

The problems with using traditional flat combs for cutting hair are many. Flat combs tend to create snags, particularly with long, coarse or thick hair, thereby creating problems for the stylist or barber. If the hair is slightly tangled, coarse or replete with “split ends,” combing while attempting to cut the hair may create significant problems for the cutter, barber or stylist. In addition, when using a flat comb, the stylist or barber must visually and manually adjust the comb's distance from the scalp to achieve the desire cut length, relying upon visual references, i.e., “eye-balling it,” all the while attempting to hold the comb in steady fashion at the appropriate height above the scalp without deviating from the desired distance. This approach introduces the opportunity for human error to the cutting process; once the hair is cut, it cannot be “uncut.” Flat combs also tend to aggregate hair from different sections of the scalp which may or may not be desired, depending on the cut or fashion sought. For a novice stylist or barber, this presents difficulties in making a proper cut. In addition, hair must often be cut at angles different than that presented by the comb as it is held in the cutting process. Furthermore, rarely is the surface of the human head, i.e., the scalp, in perfect, symmetrical shape. Most scalps are not “perfectly” shaped and contain lumps, bumps and indentations. Using the scalp as a reference point in the cutting process, therefore, may also create problems for the stylist. In sum, flat combs open the opportunity for greater human error in the cutting process and, compared to the present invention, are more difficult to use, particularly when using a “scissor and comb” method of cutting hair, as is generally known in the art. Cutting hair with a comb and scissors is an art involving a complex process of combing, holding hair and cutting involving the shifting of hands and implements (scissors and comb) and takes many hours of practice and training to become proficient. Indeed, what is really required for the stylist or barber is third hand to help in the process. The present invention, in its various embodiments, acts as a third hand and solves many of the problems associated with the traditional flat comb for cutting hair.

### SUMMARY OF THE INVENTION

The present invention deviates from traditional hair combs in many respects and solves many of the issues and challenges faced by stylists, barbers and hair cutters. In an embodiment, a novel feature of the invention is the comb's double-sided feature, wherein the teeth of the comb on each side are of a substantially triangular shape extending from a raised center support element. See, e.g., FIGS. 4-6. A comb body portion 20 of the embodiments, which comprises a plurality of shaped teeth 26 and the center support element 24, is comprised of a flat bottom surface 26D and an angled top surface 26C that is at its greatest distance at the center plane 30 running along and through the center axis 32 of the embodiments, see FIG. 4A, thereby forming an angled height to the teeth 26 at various set distances according to a particular embodiment (as discussed further herein, the heights of four (4) exemplary embodiments discussed herein and illustrated in the drawings, as defined by the maximum height of the center support element 24 at its respective center plane 30, are, respectively, 0.125 inches, FIGS. 5-6, 20A; 0.25 inches, FIGS. 8-11, 20B; 0.50 inches, FIGS. 12-15, 20C; and 1.0 inches, FIGS. 16-19, 20D). The comb body portion 20 is attached to a handle portion 10, allowing a user to hold the embodiment for use. The approximate dimensions of the four (4) embodiments are set forth in FIG. 26.

The unique shape of the comb teeth 26 and the stabilizing, hair length height of the center support element 24 allows hair to be uniformly cut at the precise height of the center support element 24. As noted, the four (4) embodiments described above are each comprised of center support elements 24 of varying heights to which the teeth 26 of each embodiment extend outward perpendicularly to form the angled comb shape. See FIG. 7. For example, the embodiment of FIGS. 5-6, 20A is comprised of a center support element 24 that is ⅛ inch (0.125 inches) in height. As such, when hair is filtered through the comb teeth 27 and cut along center support element 24 as the hair strands extend therefrom in between the teeth 27, the length of the hair will be exactly ⅛ inch (0.125 inches). The three (3) additional embodiments, as depicted in FIG. 4 and discussed above are comprised, respectively (left to right), of center support elements 24 (and thus, angled teeth heights) of ¼ inch (0.25 inches), ½ inch (0.50 inches) and one (1) inch (1.0 inches) respectively. Hair may be cut at precisely said lengths, depending on the embodiment used by the stylist or barber.

The embodiments of the invention may be used either with the flat bottom surface 26D of the comb body portion 20 immediately adjacent to and coming in contact with the scalp or the top surface 26D of the comb body portion 20 immediately adjacent to and coming in contact with the scalp. Each approach offers the stylist or barber with different options in using the invention, and therefore, able to tailor unique cuts and customized cutting designs to each client. For example, with the top surface 26D of the comb body 20 being applied directly to the scalp, as the stylist combs the hair in accordance with various cutting methods well known in the art, see, e.g., FIG. 3, the stylist may use the center support element 24 (the top surface of which 24A is in contact with the scalp) to stabilize the comb body portion and gently rock and lift the hair filtered through terminal end 26A of the comb teeth 26 outward from the scalp at a length (distance) of less than or greater than the height of the center support element 24. Such use allows the stylist to shape the hair as desired and overcome the challenges caused by bumps, lumps, indentations and other imperfections on the scalp surface.

In yet another method, the stylist may use the invention with the top surface 26C of the comb teeth applied directly to and in substantial contact with the scalp. This allows the flat bottom surface 26D of the comb teeth 26 to face outward and hair filtered through the spaces in between the teeth 26 at the center support element 24 will be at the desired length as defined by the height of the center support element 24 at the center plane 30 thereof. Because the bottom comb surface 26D is flat, the stylist or barber may use an electric clipper for easy hair cutting at an established length.

The unique design of the embodiments comprising the invention further allow for greater ease in combing tangled or knotted hair. Traditional flat combs tend to “squeeze” or compress hair and animal fur along the axle or shaft of the comb. The embodiments of the invention, however, comprise raised, angled teeth 26 in a substantially triangular shape that extend perpendicularly from the center support element 24, see FIG. 7, which allows for channeling of hair and fur in between the teeth 26, thereby providing a detangling function for knotted or tangled hair or fur and allowing for easy combing.

Embodiments of the invention further comprise detachable handle portions 10 for rapid exchange of different handle types. For example, a handle 10 of the type depicted in the embodiments may be readily detached from the connecting element or portion 22 of the comb body portion 20 and replaced with a solid handle with a coated grip material to allow for greater gripping control of the handle 10.

Embodiments of the invention further allow for the detachably attaching various attachments, such as LED lights for greater illumination of the cutting area, electric clipper guides, and any number of attachments that may assist the stylist or barber in cutting hair.

### BRIEF DESCRIPTION OF THE DRAWINGS

FIG. 1 is a perspective side view of a traditional hair comb used for combing, cutting and styling hair.

FIG. 2 is a perspective side view of a standard barber or stylist comb set, depicting several variations of the flat comb used in cutting and styling hair.

FIG. 3 is a perspective view of a barber or stylist cutting the hair of a boy, demonstrating how the traditional flat comb is used in combination with scissors to cut hair.

FIG. 4 is a perspective view of three (3) embodiments of the invention, with the flat bottom side of each embodiment facing down.

FIG. 4A is a perspective view of the three (3) embodiments of FIG. 4 and depicting the center axis and center plane as to each embodiments and further depicting the perspective views further described within the drawings and this disclosure.

FIG. 5 is a top view of an embodiment of the invention.

FIG. 6 is another top view of the embodiment of FIG. 5.

FIG. 7 a cross-sectional view of the comb body portion of an embodiment of the invention.

FIG. 8 is a perspective front/top view of an embodiment of the invention.

FIG. 9 is a further perspective front/top view of an embodiment of the invention.

FIG. 10 is a perspective front view of an embodiment of the invention, bottom side facing down (top side facing up).

FIG. 11 is a perspective front view of the embodiment of FIG. 10, bottom side facing up (top side facing down).

FIG. 12 is a perspective front view of an embodiment of the invention, bottom side facing down (top side facing up).

FIG. 13 is a perspective front/bottom view of the embodiment of FIG. 12, bottom side facing up (top side facing down).

FIG. 14 is a perspective front view of an embodiment of the invention, bottom side facing down.

FIG. 15 is a perspective top/proximal (handle) view of the embodiment of FIG. 14.

FIG. 16 is a perspective top/proximal (handle) view of an embodiment of the invention.

FIG. 17 is a further perspective top/proximal (handle) view of the embodiment of FIG. 16.

FIG. 18 is a perspective front view of the embodiment of FIG. 16, bottom side facing down (top side facing up).

FIG. 19 is a perspective front view of the embodiment of FIG. 16, bottom side facing up (top side facing down).

FIG. 20A-20D are perspective side views of various embodiments of the invention, bottom side facing down (top side facing up).

FIG. 21 is a perspective view of a clipper guide attachment for use with embodiments of the invention.

FIG. 22 is a further perspective view of a clipper guide attachment for use with embodiments of the invention.

FIG. 23 is a perspective side view of a clipper guide attachment for use with embodiments of the invention.

FIG. 24 is a perspective bottom view of a clipper guide attachment for use with embodiments of the invention depicting the attachment pegs.

FIG. 25 is a perspective top view of a clipper guide attachment detachably attached to an embodiment of the invention.

FIG. 26 is a summary chart of the approximate dimensions of various features, elements and portions of the depicted embodiments (in inches).

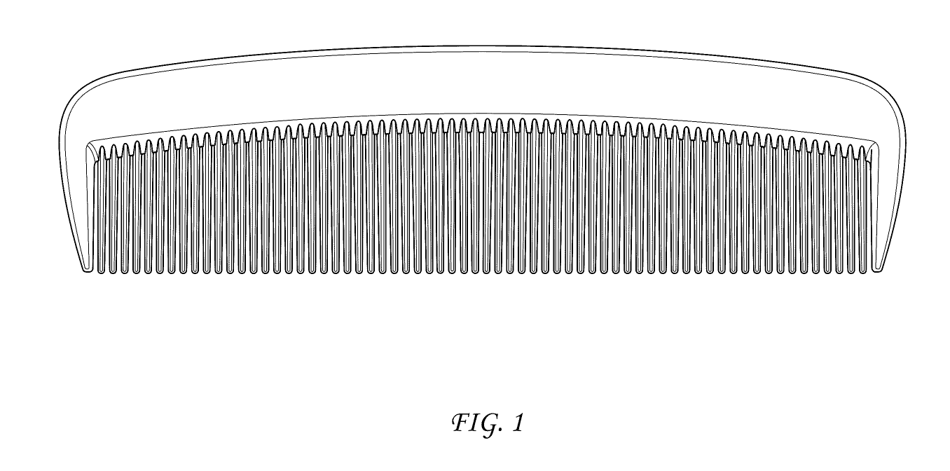

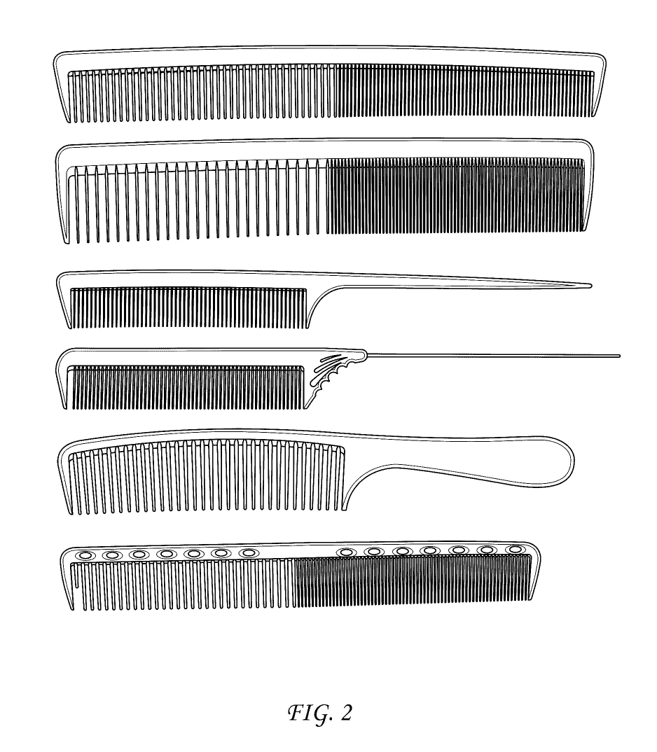

### DRAWING REFERENCES

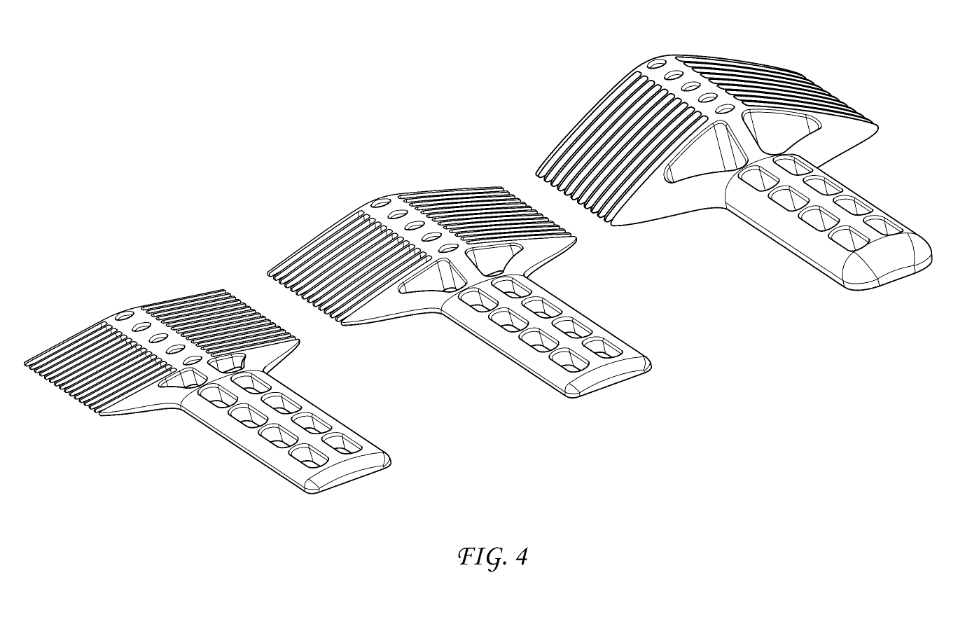

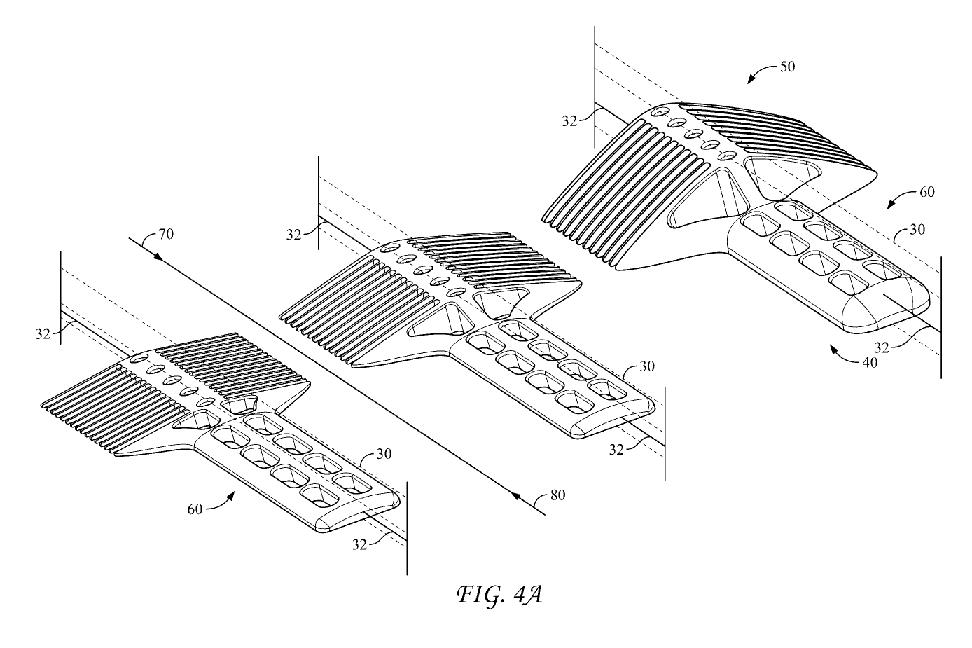

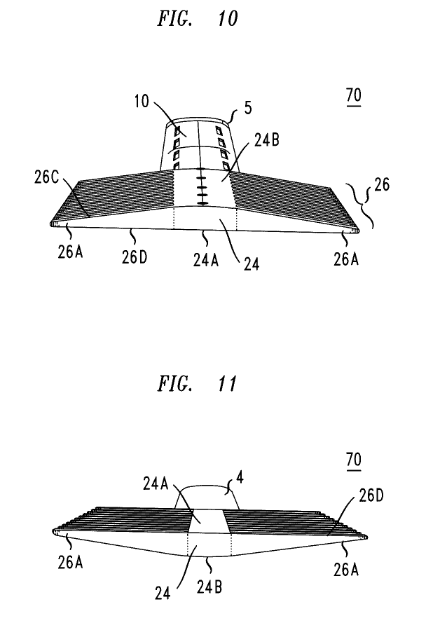

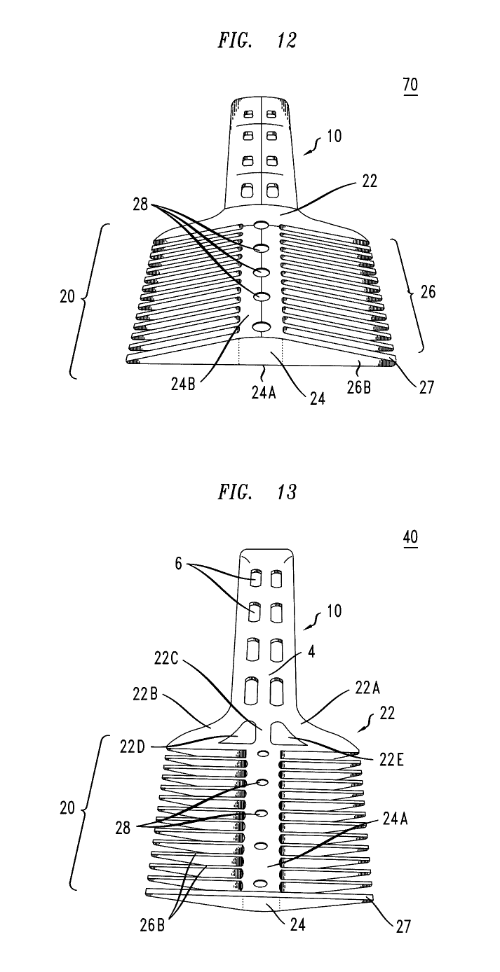

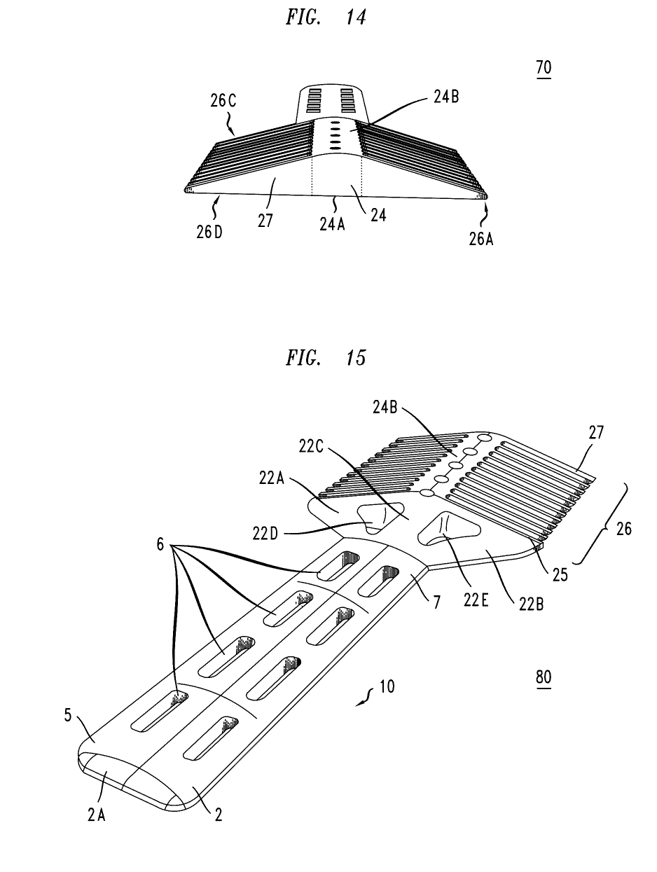

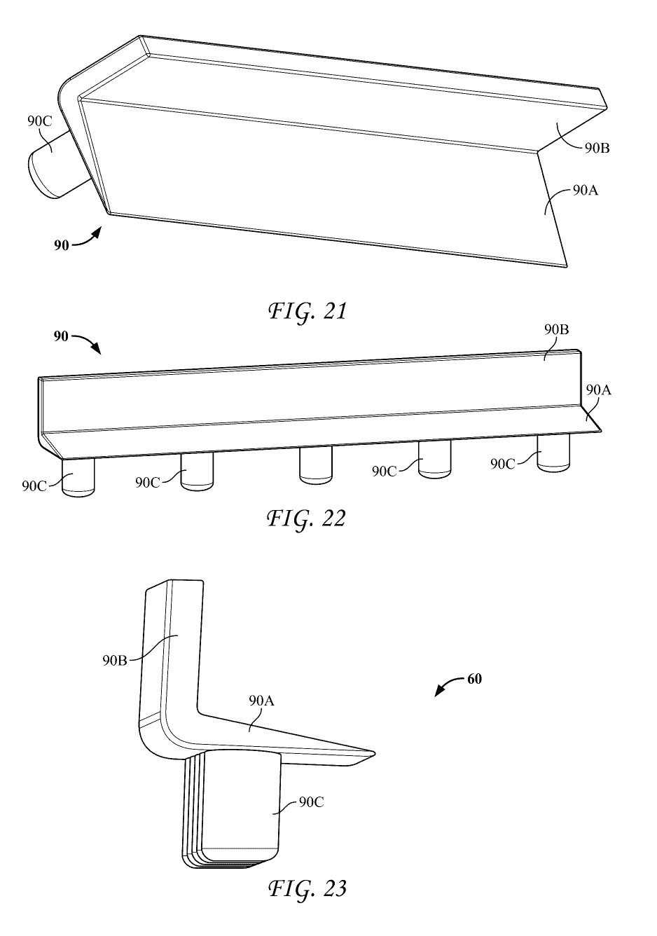

Various embodiments of the invention are disclosed in the drawings. FIGS. 4-25 depict various embodiments of the invention, including various elements, features, portions and assemblies of embodiments of the invention in closer detail. FIG. 7 depicts a cross-section view of the comb body portion of an embodiment of the invention. FIGS. 21-25 depict an attachment element that may be used with the various embodiments of the invention. FIG. 26 is a summary chart of exemplary approximate dimensions of the various embodiments of the invention disclosed herein.

For ease of reference between this disclosure and among the attached illustrations, identical reference numbers are used for various features, limitations, portions, elements, etc. of the various embodiments. The following are the various reference numbers and the associated elements and features of the embodiments and attachments as shown in the attached illustrations:
10 Handle portion
   2 Handle terminus (end portion of handle)
   2A Rounded handle terminus
   3 Center axis
   3A Center plane
   4 Bottom surface
   5 Top surface
   6 Cut-out matrices/cavities (apertures)
   7 Connecting end (detachably attached to comb body portion 20)
20 Comb body portion
   22 Connecting element
      22A First support element
      22B Second support element
      22C Center connecting support element
      22D First cavity
      22E Second cavity
   24 Center support element
      24A Flat bottom portion of center support element
      24B Top surface of center support element
      24C First side of center support element
      24D Second side of center support element
   25 Proximal support tooth
   26 Teeth
      26A Terminal edge of comb tooth
      26B Flat side surface of comb tooth
      26C Top edge of comb tooth
      26D Bottom edge/surface of comb tooth
   27 Distal support tooth
   28 Attachment aperture
30 Center plane
32 Center axis
40 Bottom portion/view
50 Top portion/view
60 Side portion/view
70 Front portion/view
80 Proximal (handle) portion/view
90 Attachment (electric clipper guide)
   90A Attachment guide base
   90B Attachment guide rail
   90C Attachment guide pegs for insertion/attachment to attachment apertures 28

The within description and illustrations of various embodiments of the invention are neither intended nor should be construed as being representative of the full extent and scope of the present invention. While particular embodiments of the invention are illustrated and described, singly and in combination, it will be apparent that various modifications and combinations of the invention detailed in the text and drawings can be made without departing from the spirit and scope of the invention. For example, references to materials of construction, methods of construction, specific dimensions, shapes, utilities or applications are also not intended to be limiting in any manner and other materials and dimensions could be substituted and remain within the spirit and scope of the invention. Accordingly, it is not intended that the invention be limited in any fashion. Rather, particular, detailed and exemplary embodiments are presented.

The images in the drawings are simplified for illustrative purposes and are not necessarily depicted to scale, although effort has been made to do so. To facilitate understanding, identical reference numerals are used, where possible, to designate substantially identical elements that are common to the figures, except that suffixes may be added, when appropriate, to differentiate such elements.

Although the invention herein has been described with reference to particular illustrative and exemplary physical embodiments thereof, as well as a methodology thereof, it is to be understood that the disclosed embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

### DETAILED DESCRIPTION

A more detailed description of the invention now follows.

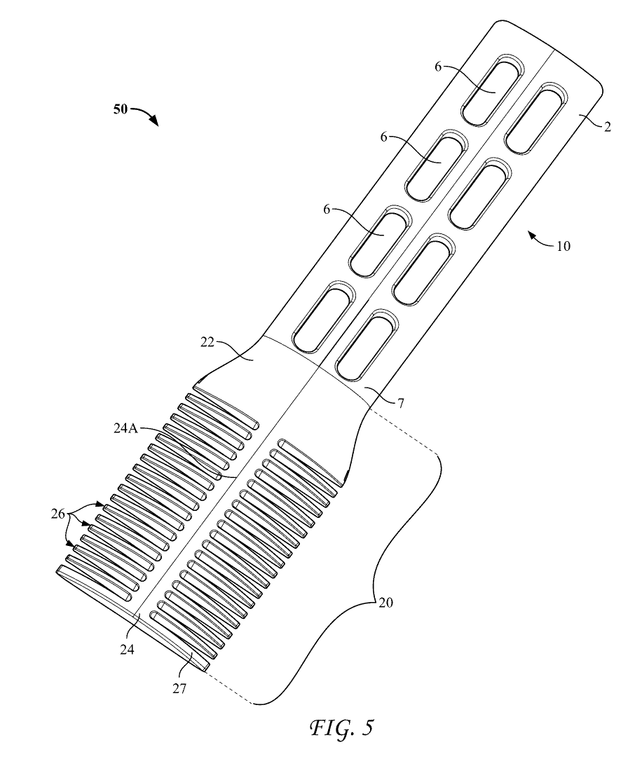

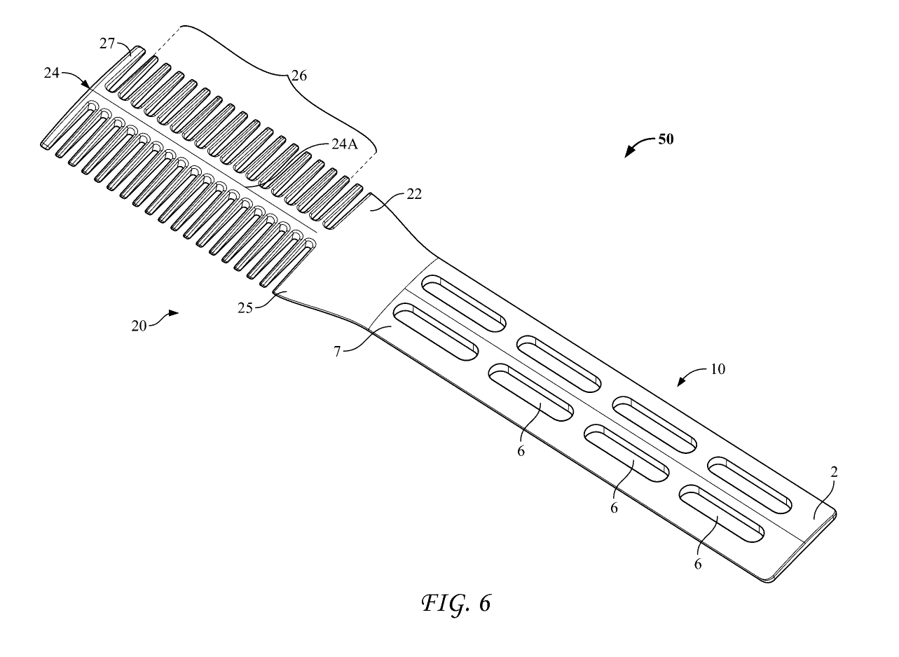

FIG. 4 is a perspective view of three (3) embodiments of the invention, with the flat bottom side 26D of the comb body portion 20 and the bottom surface 4 of the handle portion 10 of each embodiment facing down, as though the embodiments were laying on a flat surface. In the depicted embodiments of FIG. 4, the height of the central support element 24 of each embodiment, and thus, the height of the comb body portion 24 thereof, as measure by the central plane 30 of each embodiment is, respectively. 0.25 inches, 0.50 inches and 1.0 inches. FIGS. 5-6 are perspective views of a further embodiment of the invention, with the flat bottom surface 26D of the teeth 26 of the comb body portion 20 and the bottom surface 4 of the handle 10 facing down. The four (4) embodiments depicted in FIGS. 4-6 are exemplary of the invention and are examined in detail in this disclosure for purposes of describing the invention. While said embodiments are used as examples for purposes of disclosing the invention, particularly the approximate dimensions set forth as to each in FIG. 26, it is to be understood that these embodiments are merely illustrative of the invention. Therefore, numerous modifications may be made to the illustrative embodiments and other arrangements may be devised without departing from the spirit and scope of the invention. It has been contemplated that features or steps of one embodiment may be incorporated in other embodiments of the invention without further recitation.

The four (4) illustrative embodiments of FIGS. 4-6 are described in greater detail in and throughout the drawings. Regarding spatial orientation, the said four (4) embodiments of FIGS. 4-6 (and discussed further within) of the invention are comprised, generally, of a bottom portion/view or surface 40, a top portion/view or surface 50, two (2) side portions/views or surfaces 60, a front portion/view or surface 70 and a proximal (handle) view 80. Referring to FIG. 4A, the respective views 40, 50, 60, 70 and 80 are depicted. FIG. 4A also depicts the center plane 30 as described herein, which extends through and aligned with the center axis 32 of each embodiment, thereby bisecting the embodiment into two symmetric halves. The center plane 30 is substantially aligned in vertical fashion that is perpendicular (90 degrees) to the flat bottom surface 26D of the comb body portion 20. See, also, FIG. 7. This provides optimum stability and balance to the comb, particularly when in use.

Referring to the four (4) illustrative embodiments of FIGS. 4-6, and as further discussed herein, disclosed is a comb comprised of a handle portion 10 and a comb body portion 20. The handle portion 10 is further comprised of a proximal handle terminus or end portion 2, a bottom surface 4 (in the disclosed embodiments, said bottom surface 4 being flat or substantially flat and at a 90 degree angle to the center plane 30), a top surface 5 (in the disclosed embodiments, said top surface 5 comprising a raised, curved top). Optionally, as depicted in the three (3) embodiments of FIGS. 4-6, the handle portion 10 is further comprised of a plurality of cavities 6 forming matrices within the handle 10. Said cavity matrices 6 reduce the weight of the embodiment, require less material in its production or manufacture and provides strength and stability for the handle 10.

In the depicted embodiments herein, the handle portion is shown with a top surface 5 and a bottom surface 4. While the handle may further be defined to comprise a first side and a second side, both such features are described herein as comprising a curved top surface that extends from each side of the center plane 30 to a rounded intersection with the bottom surface 4. This shape of the handle 10 allows for easy holding, as opposed to handle that may comprise two sides defined by sharp angle intersections with the top and bottom surfaces of the handle. The disclosed shape of the handle 10, however, is not intended nor should be construed as a limitation of the invention.

Optionally, an embodiment is comprised of a connecting end 7 for detachable attachment to the comb body portion 20. For example, the connecting end 7 of the handle 10 may be comprised of a shaped peg or extrusion for insertion into a corresponding receiving receptacle in the connecting element 22 in a fashion that results in a tight fit. Should a handle 10 break, or should a user desire a handle of different size, weight or comprising other features, such as a non-slip stick surface, a user may detach the detachably attached handle 10 for the connecting element 22 and replace with a replacement handle 10.

The comb body portion 20 of the depicted embodiments is the primary combing portion of the invention and is attached to the handle 10. In the embodiments, the comb body portion 20 is connected to the handle portion 10 via a connecting element 22. The connecting element may take any number of shapes and employ any number of means and is not restricted to the particular sizes and shapes in the drawings. In the embodiment of FIGS. 5-6, the connecting element 22 is merely an extension of the handle 10 that widens to meet the proximal end or first support tooth portion 25 of the comb body portion 22. In the embodiments of FIG. 4, the connecting element 22 is comprised of additional elements and features that provide greater strength and stability between the handle 10 and the comb body portion 20. Specifically, the connecting element 22 in the three (3) embodiments of FIG. 4 are further comprised of a first support element 22A, a second support element 22B and a center connecting support element 22C that is parallel to and aligned with the center plane 30 of the embodiments. Continuing with FIG. 4, the connecting elements 22 of disclosed embodiments are further comprised of a first cavity 22D and a second cavity 22E.

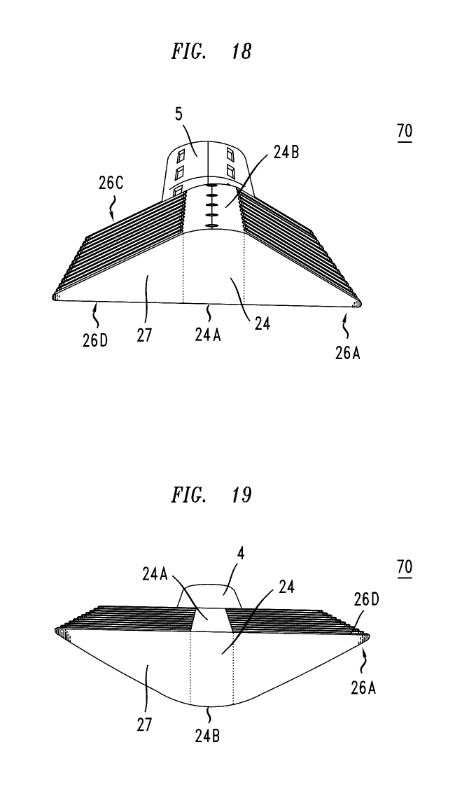

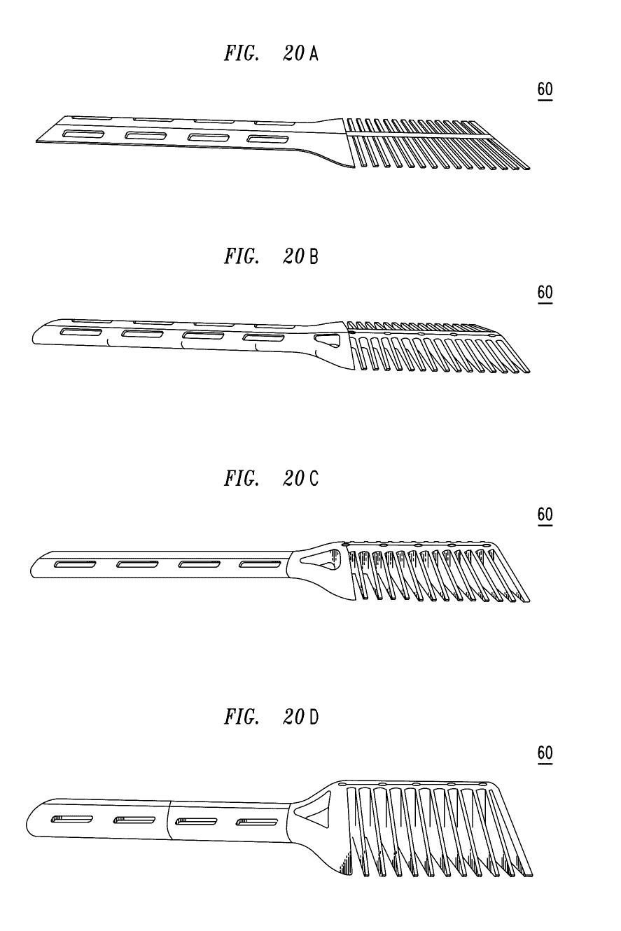

The use of cavities 22D and 22E and the first support element 22A, the second support element 22B and the center connecting support element 22C in the connecting elements 22 of the embodiments of FIGS. 4, 8-19 and 20B-D are intended to reduce the weight of the embodiments, require less material in their production or manufacture and provide strength and stability between the handle 10 and the comb body portion 20. Optionally, the three (3) embodiments of FIG. 4 may be completely solid (as demonstrated in the embodiment of FIGS. 5-6) or be comprised of additional cavities than the two (2) cavity portions 22D, 22E of the disclosed embodiments. The connecting elements 22 of disclosed embodiments of FIG. 4 provide the necessary support and stability for the large comb body portions 20 thereof. In addition, in the disclosed embodiments of FIGS. 4, 8-19 and 20B-D, the connecting elements 22 are sloped, increasing at the handle end from a height at the center plane thereof equal or substantially equal to that of the center plane 30 of the handle to the height at the center plane 30 of the at the center support element 24. This is graphically illustrated in FIGS. 20A-20D and summarized in the chart of FIG. 26.

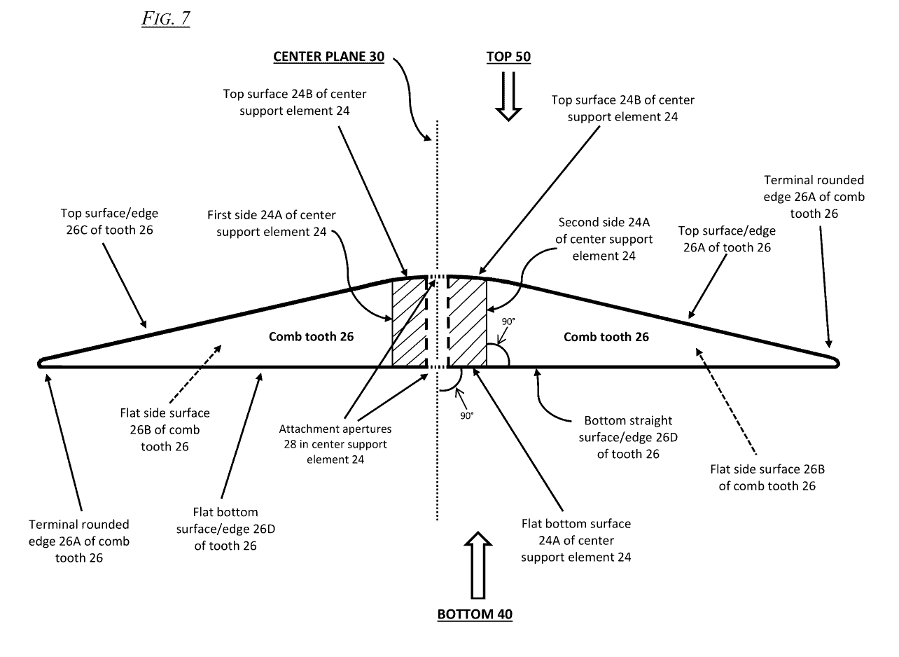

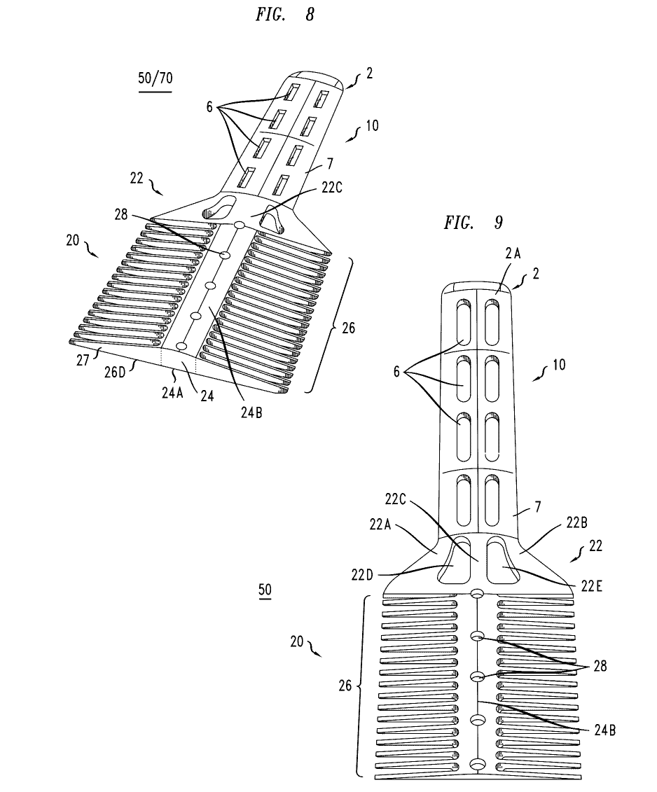

Referring to the comb body portions of the embodiments of FIGS. 4-6, as depicted in greater detail in FIGS. 8-20D, disclosed is a center support element 24 substantially parallel to and aligned with the center plane 30 and further comprised of a bottom portion 24A (in the disclosed embodiments, said bottom portion 24A is flat and congruous with and to the flat bottom portion 4 of the handle 10) and a top surface 24A. Extending perpendicularly from the two (2) sides of the center support element 24 are a plurality of comb teeth 26. On the distal front ends of the disclosed embodiments, the first set of teeth is comprised of a singular-piece, congruous distal outer support tooth 27 of greater thickness than the internal teeth 26 of the comb body portion 20 so as to provide strength, stability and an outer shield to protect the inner teeth 26 from breaking. Referring again to the embodiments of FIGS. 4-6, as depicted in greater detail in FIGS. 8-20D, the proximal end of the comb body portion 20 of the embodiments is comprised of an inner, proximal support tooth 25, which may, depending on the precise configuration and alignment of the connecting element 22 be one and the same (i.e., the proximal support tooth 25 may also function as the connecting element 22). That is, the distal end of the connecting element 22 may comprise the inner, proximal support tooth 25 or means to protect the inner teeth 26 from breaking.

FIG. 7 depicts a cross-sectional perspective of the comb body portion 20 of the embodiments for illustrative purposes. In the view of FIG. 7, the top surface/view 50 of the comb body portion 20 is facing up and the bottom surface/view 40 is facing down as though the embodiment is laying on a flat, zero-degree surface. The center plane 30 is aligned perpendicularly, at a 90-degree angle, with the flat bottom surface/view 40 of the embodiment, defined by the flat bottom surface/edge 26D of the comb teeth 26 and the flat bottom surface 24A of center support element 24. The cross-section of the center support element 24 is marked with diagonal lines. The top surface 24B of center support element 24 is substantially parallel to the flat bottom surface 24A of the support element 24, with slight curve. The center support element is further defined by a first side 24C and a second side 24D, to which the bottom edges 26D of the comb teeth 26 extend in a substantially perpendicular manner. The first side 24C and second side 24D of the center support element 24 are generally and substantially parallel to the center plane 30. The comb teeth 26 extend from each of the two sides 24C, 24D of the center support element 24. At the intersection of the top surface 24B of the center support element 24 with the center plane 30, said top surface is perpendicularly thereto, at a 90-degree angle, with the center plane 30.

Continuing with FIG. 7, extending horizontally for each side of the center support element 24 are a plurality of comb teeth 26. The comb teeth 26 are of substantially triangular shape, the three sides of which are defined by a top surface/edge 26A, a bottom straight surface/edge 26D and the connecting edge with the side of the center support element 24 (not marked with a reference number). The outward angle or terminal edge 26A of the comb tooth 26 is rounded, as the terminal edge 26A represents the point of the comb tooth 26 and comes in direct contact with the sensitive scalp of the head or other body part when combing hair, thus preventing injury or pain when applied to the scalp during combing. The point-rounded terminal edge 26A of the teeth 26 prevents the comb teeth 26 from scratching the scalp of a head or underlying skin. It further allows the comb to move through hair and fur more smoothly, without snagging and provides a comfortable and pleasant sensation against the scalp.

The substantially triangular shape of the comb teeth 26 is further defined by a substantially 90-degree angle at the junction formed where the flat bottom surface 26D of the comb tooth extends from the first and second sides 24C, 24D of the center support element 24, as depicted in FIG. 7. As noted, the height of the center support element 24 in the various embodiments substantially defines the height of the comb body portion 20, and thus the unreferenced third side of the substantially triangular comb tooth 26 that extends from the center support element 24. As such, given embodiments of the invention comprising center support elements 24 having respective heights of 0.125, 0.25, 0.50 and 1.0 inches, the unreferenced third side of the substantially triangular comb teeth 26 of said embodiments (extending from the first side 24C and second side 24D of center support element 24) would substantially comprise, respectively, lengths or comb heights of 0.125, 0.25, 0.50 and 1.0 inches. In sum, the greater the height of the center support element 24 of an embodiment, the greater the height of the comb teeth 26—which translates, generally, into longer cut lengths of hair and different style cuts.

Continuing with FIG. 7, also depicted are cross-sectional views of two (2) attachment apertures 28 in the center support element 24. One aperture 28 is depicted on the top surface 24B of the support element 24 and extending therein; the other aperture 28 is depicted on the flat bottom surface 24A of the center support element 24 and extending therein. In the embodiment of the cross-sectional view of FIG. 7, the internal cavities formed by the apertures 28 in the center support element 24 connect within the center support element 24, thereby forming a congruous internal channel within the element 24. As noted, the apertures 28 and the cavities formed therefrom and extending internally into the center support element 24 are for receiving corresponding elements of various attachments, see FIGS. 21-25, for detachable attachment to either the top surface 24B or the flat bottom surface 24A of the center support element 24.

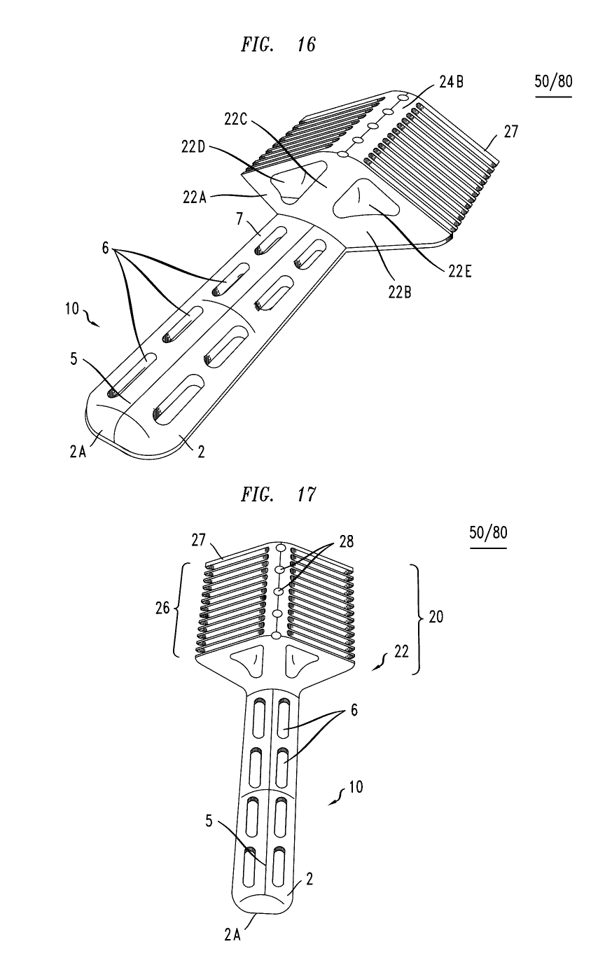

Continuing further with FIG. 7, the flat side surface 26B of the two (2) representative comb teeth 26 are depicted. Generally, a smooth surface is desired for the flat side surface 26B of the comb teeth 26 to allow for ease in combing hair or fur. A primary purpose of the combs, in general, is to smoothly glide through the hair or fur, filter and separate strands of hair/fur and detangle knots or tangles. A smooth surface to the flat side surface 26B of the comb teeth 26 provides for these objectives. It should be noted that, generally, comb teeth are typically of a width sufficient to provide the function of combing, without being subject to breakage. In the various embodiments, the comb teeth 26 are finer (lesser width) on embodiments that comprise a lesser comb body portion 20 height and of greater width on embodiments that comprise a greater comb body portion 20 height. Embodiments are not restricted to a defined number of plurality of teeth 26 and the space in between the teeth of the comb also varies and is typically of a sufficient width to allow for the combing function sought. For example, turning to the embodiment of FIGS. 16-19, 20D, wherein the height of the comb body portion is approximately 1.0 inches, the teeth 26 are of greater width and the space between each tooth 26 is of greater width than the embodiment of FIGS. 5-6, 20A, which comprises much finer teeth 26. As such, the embodiment of FIGS. 16-19, 20D, provides preferred combing and detangling functions on pets with thick, tangled fur or on long, tangled human hair.

Referring to the embodiment of FIGS. 5-6, the height of the comb (again, defined at the center plane 30 as it extends through the central support element 24) is 0.125 inches (⅛ inch). This particular embodiment, therefore, provides for the cutting of hair at a length of substantially 0.125 inches when used as previously described. Because of its relative lighter weight as compared to the other depicted embodiments, the connecting portion 22 is a solid piece to provide maximum stability—any reduction in weight or material by utilizing cavities 22D, 22E and support elements 22A, 22B, 22C would be minimal.

FIGS. 8-11, 20B depict an embodiment of the invention comprising a comb body portion 20 height of substantially 0.25 inches. Unlike the embodiment of FIGS. 5-6, 20A, the connecting element 22 of the embodiment of FIGS. 8-11, 20B is not solid and comprises a first support element 22A, a second support element 22B, a center connecting support element 22C (that is substantially aligned along the axis of the center plane 30 and congruous with the center support element 24), a first cavity 22D and a second cavity 22E. The center support element 24 of the comb body portion 20 comprises apertures 28 on the top surface 24B and the flat bottom surface 24A for receiving attachments that may be detachably attached to the comb body portion 20. In the perspective views of FIGS. 10-11, the center support element 24 is further defined on the distal support tooth 27 on the front view 70 by hashed lines. Note the substantially triangular set of teeth 26 extending perpendicularly from the two (2) sides of the center support element 24.

FIGS. 12-15, 20C depict an embodiment of the invention comprising a comb body portion 20 height of substantially 0.50 inches. Unlike the embodiment of FIGS. 5-6, 20A, the connecting element 22 of the embodiment of FIGS. 12-15, 20C is not solid and comprises a first support element 22A, a second support element 22B, a center connecting support element 22C (that is substantially aligned along the axis of the center plane 30 and congruous with the center support element 24), a first cavity 22D and a second cavity 22E. The center support element 24 of the comb body portion 20 comprises apertures 28 on the top surface 24B and the flat bottom surface 24A for receiving attachments that may be detachably attached to the comb body portion 20. In the perspective views of FIGS. 12, 14 the center support element 24 is further defined on the distal support tooth 27 on the front view 70 by hashed lines. Note the substantially triangular set of teeth 26 extending perpendicularly from the two (2) sides of the center support element 24.

FIGS. 16-19, 20D depict an embodiment of the invention comprising a comb body portion 20 height of substantially 1.0 inches. Unlike the embodiment of FIGS. 5-6, 20A, the connecting element 22 of the embodiment of FIGS. 16-19, 20D is not solid and comprises a first support element 22A, a second support element 22B, a center connecting support element 22C (that is substantially aligned along the axis of the center plane 30 and congruous with the center support element 24), a first cavity 22D and a second cavity 22E. The center support element 24 of the comb body portion 20 comprises apertures 28 on the top surface 24B and the flat bottom surface 24A for receiving attachments that may be detachably attached to the comb body portion 20. In the perspective views of FIGS. 18-19, the center support element 24 is further defined on the distal support tooth 27 on the front view 70 by hashed lines. Note the substantially triangular set of teeth 26 extending perpendicularly from the two (2) sides of the center support element 24.

FIGS. 21-25 depict a detachable attachment 90 for use with embodiments of the invention having attachment apertures 28 in the center support element 24. The attachment 90 depicted is an electric clipper guide comprising an attachment guide base 90A, attachment guide rail 90B and a plurality of attachment guide pegs 90C. The guide pegs 90C of the clipper guide attachment 90 are of sufficient dimensions and number for alignment with their corresponding attachment apertures 28 on either the top surface 24B or bottom surface 24A of the center support element 24. When detachably attaching the attachment 90 to the center support element 24, the attachment pegs 90C align with the apertures 28 and the apertures 28, and the cavities formed therefrom that internally extend into the center support element 24, comprise receiving receptacles for the attachment pegs 90C. When inserted into the apertures 28, the pegs 90C detachably detach the electric clipper guide attachment 90 to the center support element 24 in secure fashion. Ideally, the apertures 28 and the internal receiving receptacles therefrom in the center support element 24 are of sufficient size and shape for a snug, secure fit with the pegs 90C of the attachment 90. The attachment 90 may be removed from the comb body portion 20 by manually grasping the attachment 90 and asserting a firm pull to disengage the pegs 90C from the apertures 28 and the internal receiving receptacles, thereby detaching the attachment from the center support element 24.

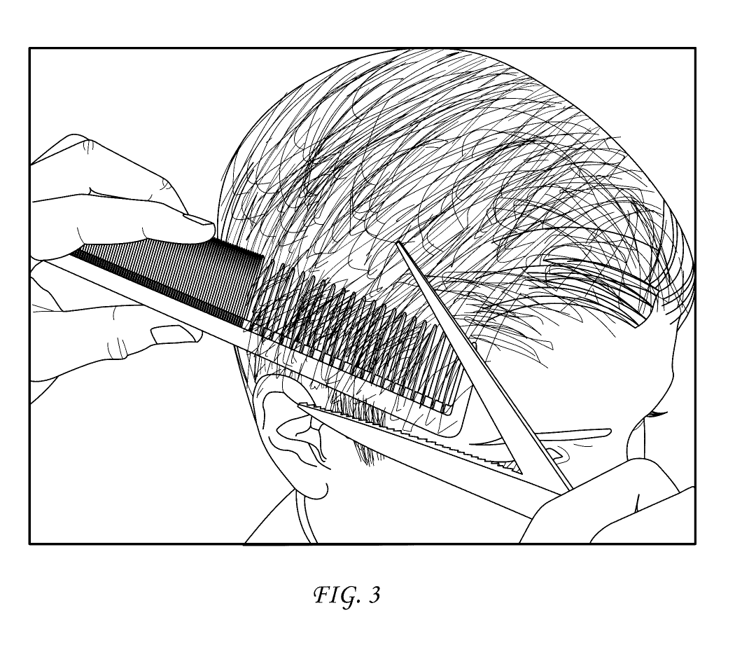

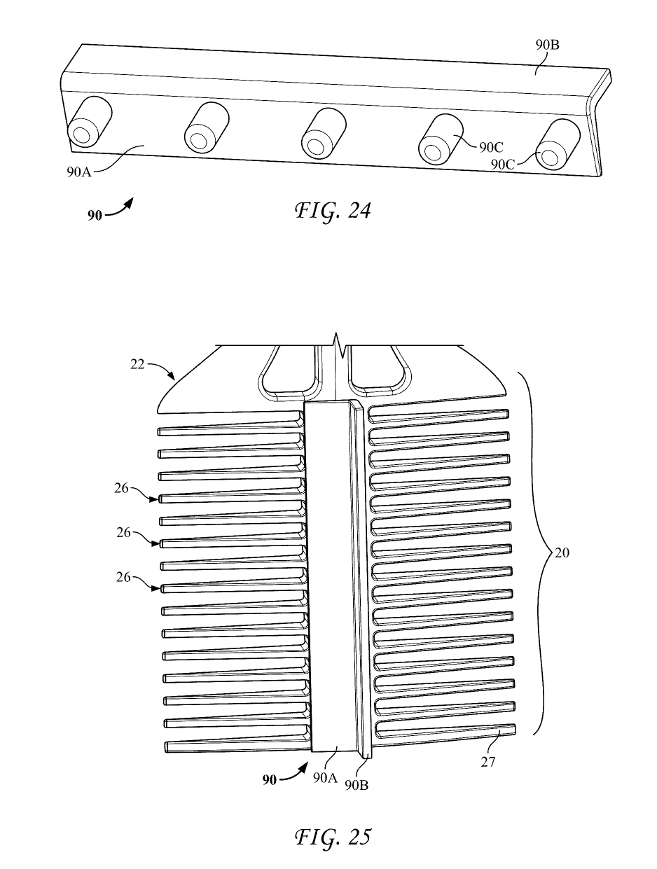

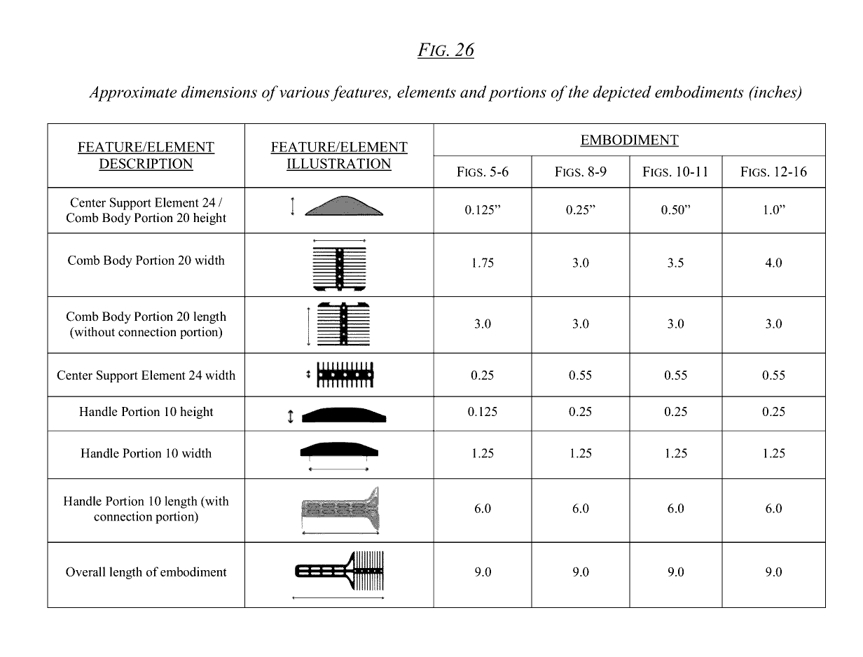

FIG. 25 depicts the clipper guide attachment 90 attached to the bottom flat surface 24A of the center support element 24 for use with an electric clipper. As the top surface 24B of the comb body portion 20 is combed through the hair in the manner depicted in FIG. 3, a user may easily apply an electric clipper along the rail 90B of the attachment 90 for quick, easy hair cutting at a hair length substantially defined by the height of the center support element 24.

FIG. 26 is a summary chart depicting approximate dimensions of various elements, features and portions of the embodiments disclosed herein. The summary chart presents examples of embodiment dimensions and is not intended nor should be interpreted of limitations on the scope of the invention disclosed herein.

The various embodiments of the invention disclosed may be constructed from a variety of durable materials typically used for combs, such as plastics, resins and any other suitable material. Typical modern materials include high-density polyethylene (HDPE), polyvinyl chloride (PVC), low-density polyethylene (LDPE), polypropylene (PP), high impact polystyrene (HIPS), acrylonitrile butadiene styrene (ABS), polycarbonate (PC), polycarbonate/acrylonitrile butadiene styrene (PC/ABS). In addition, embodiments may be constructed from dense and consistently pliable but stiff cellulose acetate, which has a glossy outer hand finish that also glides over hair more easily and without snags.

The embodiments may be produced by any generally known means, such as extrusion or injection molding, casting and the like. The embodiments of the invention may also be constructed from wood or other traditional materials used to make combs before modern hard plastics and constructed by hand or in known wood-working and artisan methods. Any materials and methods used to make hair combs, in general, would be similarly suitable for the disclosed invention, including historic, non-modern materials and methods.

This description is neither intended nor should it be construed as being representative of the full extent and scope of the present invention.

This disclosure of the various embodiments of the invention, with accompanying drawings, is neither intended nor should it be construed as being representative of the full extent and scope of the present invention. The images in the drawings are simplified for illustrative purposes and are not necessarily depicted to scale. To facilitate understanding, identical reference terms are used, where possible, to designate substantially identical elements that are common to the figures, except that suffixes may be added, when appropriate, to differentiate such elements.

Although the invention herein has been described with reference to particular illustrative embodiments thereof, it is to be understood that these embodiments are merely illustrative of the principles and applications of the present invention. Therefore, numerous modifications may be made to the illustrative embodiments and other arrangements may be devised without departing from the spirit and scope of the present invention. It has been contemplated that features or steps of one embodiment may be incorporated in other embodiments of the invention without further recitation.

1. A comb, comprising a handle portion and a comb body portion, wherein:
the handle portion is comprised of a bottom surface, a top surface, a proximal end and a distal end; and
the comb body portion is comprised of a connecting portion attached to the handle portion, a raised center element comprising a top surface, a bottom surface, a first side and a second side, and a plurality of comb teeth extending from the first side and the second side of the central support element.

2. The comb of claim 1, wherein the bottom surface of the handle portion and the bottom surface of the comb body portion are substantially flat and congruous

3. The comb of claim 2, wherein the bottom surface of the comb body portion is substantially perpendicular to a vertical center plane extending through the comb.

4. The comb of claim 1, wherein the comb teeth are substantially triangular in shape and comprise a bottom surface/edge, a top surface edge and a side edge.

5. The comb of claim 4, wherein the side edge of the comb teeth extend from the first side and the second side of the center support element.

6. The comb of claim 4, wherein the side edge of the comb teeth are substantially perpendicular to the bottom edge of the comb teeth.

7. The comb of claim 1, wherein the top surface of the center support element and the bottom surface of the center support element are further comprised of at least one attachment receiving aperature for a detachable attachment of an attachment to the center support element.

8. The comb of claim 7, wherein the attachment comprises a base, guide rail and at least one attachment peg for detachable attachment of the attachment to the center support element.

9. The comb of claim 1, wherein the comb body portion is further comprised of a distal support tooth.

10. The comb of claim 1, wherein the handle portion is further comprised of at least one cavity extending from the top handle surface to the bottom handle surface.

11. The comb of claim 1, wherein the connecting portion is comprised of at least one cavity extending from the top surface of the connecting portion to the bottom surface of the connecting portion and an at least two support elements.

12. The comb of claim 11, wherein the connecting portion is comprised of a first cavity, a second cavity, a first support element, a second support element and a center connecting support element.
